(19) United States
(12) Patent Application Publication
(10) Pub. No.: US 2014/0092763 A1
(43) Pub. Date: Apr. 3, 2014

(54) METHOD FOR MANAGING A WIRELESS SENSOR NETWORK, AND CORRESPONDING SENSOR NODE, SENSOR NETWORK, AND COMPUTER PROGRAM PRODUCT

(71) Applicant: Nicola De Carne, Rivoli (IT)

(72) Inventor: Nicola De Carne, Rivoli (IT)

(21) Appl. No.: 14/009,466

(22) PCT Filed: Apr. 5, 2012
(86) PCT No.: PCT/IB12/51703

§ 371 Date: Dec. 5, 2013

(30) Foreign Application Priority Data
Apr. 8, 2011 (IT) TO2011A000317

(51) Int. Cl. H04W 24/02; H04W 84/18

(52) U.S. Cl. CPC H04W 24/02; H04W 84/18
USPC 370/252

(57) ABSTRACT

A method for managing a wireless sensor network comprising a plurality of sensor nodes, in which the sensor nodes are configured for detecting physical quantities. The method includes setting at least one configuration parameter identifying a service density or monitoring resolution and detecting for a sensor node which physical quantities are detected via respective surrounding sensor nodes. It is verified for the sensor node whether the sensor node is configured for detecting a physical quantity that is also detected via one of the surrounding sensor nodes. It is determined according to the configuration parameter identifying a service density or monitoring resolution, whether the sensor node must activate or de-activate detection of the physical quantity that is also detected via surrounding sensor nodes.

### FIELD OF THE INVENTION

The present invention relates to communication systems and methods for wireless sensor networks (WSNs).

The invention has been developed with particular attention paid to its possible use for enabling communication between a set of autonomous electronic devices that are able to collect data from the surrounding environment and to communicate with one another.

### DESCRIPTION OF THE RELEVANT TECHNIQUE

Recent technological progress has made it possible to develop low-power electronic devices that are able to communicate with one another via limited-range wireless technologies.

Frequently, these devices comprise a control unit that communicates with at least one sensor. For example, for said purpose, the control unit usually comprises a plurality of inputs and/or outputs for interfacing with at least one sensor. In this way, the device is able to detect physical quantities (such as, for example, temperature, humidity, and/or position). For this reason, said devices are frequently called sensor nodes.

Consequently, a sensor network comprises a plurality of sensor nodes. For example, FIG. 1 shows a typical scenario of such a sensor network comprising six nodes A, B, F, in which each node comprises a processing and communication module 10 and an interface module 20 for connection to at least one sensor. In particular, in the embodiment considered, the processing and communication module 10 comprises a wireless communication interface and a control unit that detects the data measured via the sensors and manages the wireless communication.

Preferably, said nodes communicate with one another via a short-range wireless communication, and the data are sent to one or more main nodes, referred to as “sink” or “gateway” nodes, which have the purpose of collecting the data and transmitting them, for example, to a server.

Frequently, communication between the nodes is based upon a “multi-hop” communication protocol, such as for example the protocols ZigBee® or N.A.A.W. (Nuovo Apparato Autoconfigurabile Wireless—New Wireless Self-configuring Apparatus), i.e., the nodes themselves function as repeaters for transmitting the signal from the closer nodes to the nodes that are too far away to be reached directly by the sink node. In this way, the sensor network is able to cover large distances that exceed the distance of communication of the single node. For example, in the embodiment considered, the node A could transmit data to the node E through the nodes B and D.

For example, in the case where the network is provided via N.A.A.W. devices, it would present the following properties:
the network is a level-3 multi-hop mesh Wireless Fidelity (WiFi) network, for enabling a high number of hops;
the routing intelligence is actually distributed over the entire network and not defined by a central mesh server; and
the nodes are self-configurable in a completely autonomous way by defining the routing tables in real time.

In general, the sensor network can comprise not only sensor nodes, but also nodes that function exclusively as repeaters or that perform other functions.

For example, the node D could be used only as repeater node.

Moreover, in the case where the network is a wireless local-area network (W-LAN) according to the standard IEEE 802.11, one of the nodes, for example, the node C, can be an access node (i.e., access point) of a client type configured for supplying access and communication services to a plurality of user devices.

Likewise, one of the nodes, for example the node A, can be a gateway node for supplying access and communication services to a wide-area network (WAN). In this case, the node in gateway function can also receive configuration parameters from a server and transmit them to one of the nodes of the network. For example, said server can be connected to the same wide-area network, such as, for example, the Internet, and comprises program modules of a known type for enabling exchange of information between devices of the network and devices connected to the wide-area network. In this case, the server, for example, a personal computer of a known type, comprises stored therein a configuration engine designed to configure the nodes of the network.

Said N.A.A.W. network is described in detail in the patent application No. PCT WO2008/010248 filed in the name of the same present applicant, the contents of which are entirely incorporated herein for reference.

Irrespective of the specific communication protocol used, the sensor nodes are frequently supplied only via a battery and/or a solar panel, i.e., many nodes of the network can have a limited energy reserve and, once installed, must work autonomously. Consequently, said nodes must optimize their energy consumption in such a way as to improve their life cycle.

### OBJECT AND SUMMARY OF THE INVENTION

The object of the invention is to provide a sensor node that will be able to optimize its energy consumption.

In fact, the inventors have noted that, in order to reduce the energy necessary for transmission of the data between the various nodes, it is possible to reduce the distance between the various nodes. However, this can introduce redundancy in the data measured, because nodes that are close to one another measure the same values without adding further information.

Consequently, the sensor node according to the present invention is able to determine autonomously and in co-operation with the nodes that are close thereto, which sensors must be activated for guaranteeing a given density of the services or monitoring resolution.

With a view to achieving the aforesaid object, the subject of the invention is a method for managing a sensor network having the characteristics specified in Claim 1. The invention also regards a corresponding sensor node and a corresponding sensor network. Further advantageous characteristics of the invention form the subject of the dependent claims.

The invention also regards a computer program product, which can be loaded into the memory of at least one computer and comprises portions of software code that can implement the steps of the method when the product is run on at least one computer. As used herein, the reference to such a computer program product is understood as being equivalent to the reference to a computer-readable means containing instructions for controlling the processing system to co-ordinate implementation of the method according to the invention. The reference to “at least one processor” is evidently intended to highlight the possibility of the present invention being implemented in a modular and/or distributed form.

Further advantageous characteristics of the invention form the subject of the annexed dependent claims.

The claims form an integral part of the technical teaching provided herein in relation to the invention.

In various embodiments the wireless sensor network comprises a plurality of sensor nodes, wherein the sensor nodes are configured for detecting physical quantities.

In various embodiments, at least one configuration parameter identifying a service density or monitoring resolution is set for the entire sensor network and/or for each sensor node.

In various embodiments, each sensor node detects which physical quantities are detected via respective sensor nodes surrounding the sensor network, such as, for example, sensor nodes that can be reached directly by the respective sensor node or nodes within a pre-set range. Then, the sensor node verifies whether one of the surrounding sensor nodes detects the same physical quantity and determines, according to the configuration parameter identifying the service density or monitoring resolution, whether the detection of said physical quantity must be activated or de-activated.

### BRIEF DESCRIPTION OF THE ANNEXED DRAWINGS

The invention will now be described purely by way of non-limiting example with reference to the annexed representations, wherein:

FIG. 1 has already been described previously; and

FIGS. 2 and 3 show possible embodiments of a sensor network.

### DETAILED DESCRIPTION OF EMBODIMENTS

In the ensuing description various specific details are illustrated aimed at an in-depth understanding of the embodiments. The embodiments may be provided without one or more of the specific details, or with other methods, components, materials, etc. In other cases, known structures, materials, or operations are not shown or described in detail so that various aspects of the embodiments will not be obscured.

Reference to “an embodiment” or “one embodiment” in the framework of the present description is meant to indicate that a particular configuration, structure, or characteristic described in relation to the embodiment is comprised in at least one embodiment. Hence, phrases such as “in an embodiment” or “in one embodiment” that may be present in different points of this description do not necessarily refer to one and the same embodiment. In addition, particular conformations, structures, or characteristics can be combined in any adequate way in one or more embodiments.

The references used herein are only provided for convenience and hence do not define the sphere of protection or the scope of the embodiments.

As mentioned previously, the object of the invention is to optimize the energy consumption within a sensor network. In particular, the sensor nodes according to the present invention are able to determine autonomously and in co-operation with the nodes close thereto, which sensors must be activated for guaranteeing a given service density or monitoring resolution, or vice versa which sensors can be de-activated for maintaining a given service density or monitoring resolution.

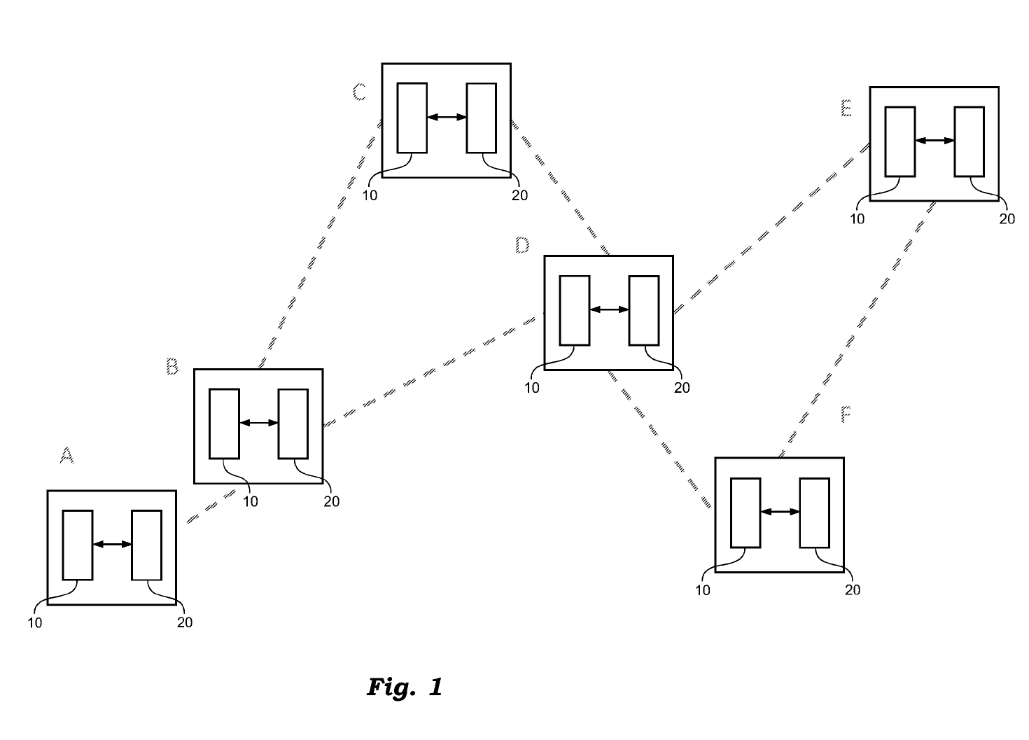

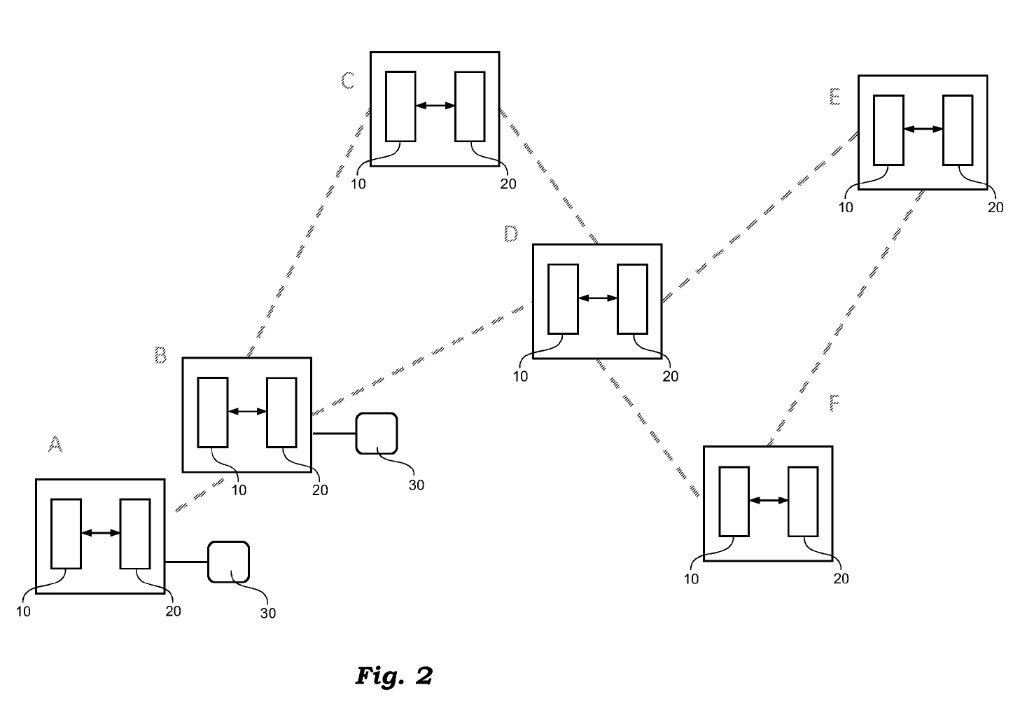

FIG. 2 shows a typical scenario of a sensor network that presents substantially the same architecture as the one already described previously with reference to FIG. 1.

Also in this case, the sensor network, such as for example a mesh WiFi network, comprises sensor nodes provided with sensors and/or actuators. For example, in the embodiment considered, both the node A and the node B comprise a respective temperature sensor 30.

In the embodiment considered, each public sensor node makes available for a possible exportation the services present on the respective node.

For example, in the case where the sensor network is based upon the N.A.A.W. protocol or a protocol that is similar from the functional standpoint, the communication protocol comprises a limited set of commands and associated messages designed to enable configuration of the network nodes. For example, the protocol comprises a limited number of configuration commands that enable modifications of configuration parameters and/or files present on the network nodes. For example, the configuration commands provided can be:
“GET” for requesting the value of a variable;
“SET” for requesting setting of the value of a variable; and
“REALTIME” for requesting execution of an operation in real time on the network node.

In one embodiment, said commands are transmitted by means of messages, which are also in limited number, written, for example, in XML (eXtensible Markup Language) format and in a standardized form of the type:

```
<request>
    <reqType>GET</reqType>
    <elementIp>10.20.33.12</elementlp>
    <name>/proc/net/arp</name>
    <regexp>[!CDATA[(([0-9A-
F]{2}:*){6})]</regexp>
    <delimeter>,</delimeter>
    <value></value>
</request>
```

where the field
“ReqType” contains the commands “GET”; “SET”, or “REALTIME”;
“elementIp” has as content the IP address of the network node;
“name” has as content, in the case of “GET” or “SET” commands, the name of the configuration file to be accessed, and in the case of “REALTIME” command the command or program to be executed;
“regexp” has as content a regular expression for formatting variables present on the nodes before sending them back to the requesting node, such as, for example, the network server;
“delimiter” indicates a delimiter in the case where the variables are more than one; and
“value” has as content, for the command “SET”, the variable to be written in the file “name”, for the command REALTIME the arguments used for starting the command “name”.

What has been described above enables execution of functions of provisioning, assurance, upgrading, and diagnosis on the individual access points of the network according to what is described in detail in the patent application No. WO2008/010248 and in the documentation on N.A.A.W. technology.

Consequently, each node is able to detect which services are active on the surrounding nodes. For example, in the embodiment considered, the node A can send a message to the surrounding nodes and request via the command “GET” which sensors are connected to the respective sensor nodes.

Said query can be made at the moment when the node is active and/or periodically. Moreover, instead of using a querying protocol of the “pull” type, each node can also publish, via a protocol of the “push” type, for example via messages of the broadcast type, its available and/or currently active services.

Consequently, after an initial step of discovery of the services available in the network, a node can determine which services are available on the surrounding nodes, and the node can evaluate which of its own services must be kept active and made available.

For example, in the embodiment considered, in the case where the distance between the nodes A and B is short and the datum sampled is substantially the same, one of the two nodes can de-activate its temperature sensor and use the data supplied by the other node.

For example, in the embodiment considered, when a node is activated, the node detects via known techniques the identifications of the surrounding nodes. Next, the node determines for each surrounding node which services are available and estimates, for example on the basis of the power of radiation received, the distance between itself and the respective node. Finally, the node compares the type of the services made available by the surrounding nodes with its own services and determines, according to the respective estimated distances and a configuration value indicating a given service density or monitoring resolution, which of its own sensors must be activated and/or which sensors can be de-activated.

In one embodiment, each service has a configuration value of its own indicating a respective service density or monitoring resolution. For example, in this way, the temperature could present a high monitoring resolution, whilst for the position it could be sufficient for just one Global-Positioning-System (GPS) sensor to be active for the entire network.

In one embodiment, the configuration value or values indicating the service densities or monitoring resolutions can be set, for example via the commands “GET” and “SET” described previously.

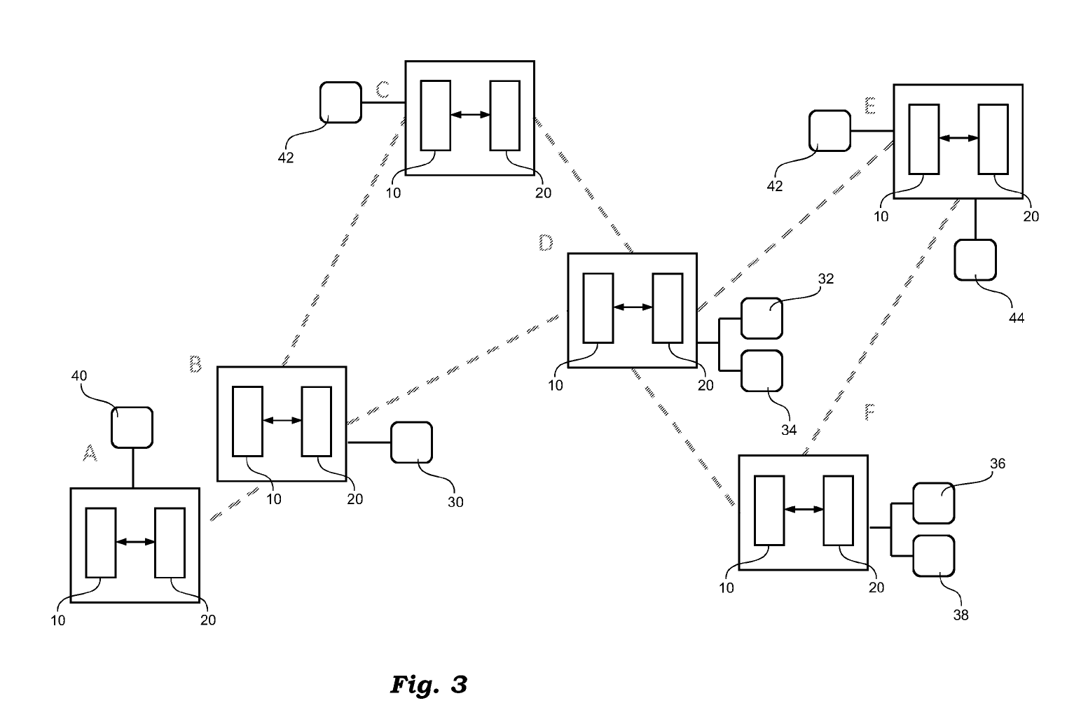

FIG. 3 shows one embodiment of the network after the initial step in which the services to be kept active on the individual nodes are identified autonomously.

For example, in the embodiment considered:
the node A is a node of the gateway type that supplies access and communication services to a wide-area network (WAN), such as for example the Internet, via a wide-band connection 40, such as for example a Digital Subscriber Line (DSL);
the node B has activated its temperature sensor 30;
the node C has activated a service 42 that configures the node C as access point configured for supplying access and communication services to a plurality of user devices;
the node D has activated a position sensor 32, such as, for example, a GPS receiver, and a radiation sensor 34, such as, for example, a light sensor;
the node E is a node of the fallback gateway type, namely, an auxiliary gateway with a low connection rate, which supplies auxiliary access and communication services to the wide-area network (WAN), such as for example the Internet, via a mobile communication device 44, such as, for example, a Universal Mobile Telecommunications System (UMTS) or High Speed Downlink Packet Access (HSDPA) modem; moreover the node E has also activated a service 42 that configures the node E as access point configured for supplying access and communication services to a plurality of user devices; and
the node F has activated a water-level sensor 36 and a dewatering-pump actuator 38.

Hence, the solution described herein enables creation of networks of sensors and actuators in a simple way thanks to the characteristic of self-configuration of the network.

This enables also reduction of the costs of installation of the network, which could also be created in temporary mode, for example for management of situations of environmental crisis.

Moreover, thanks to the possibility of setting the respective control parameters at the network level via a central server, the density and resolution of the network services can be modulated automatically in real time, and the energy consumption is optimized because only the services necessary are activated and the unused services are de-activated.

De-activation of unused services enables also further reduction of the energy consumption because the transmission of redundant environmental data can be prevented. In fact, said de-activation of the services can also result in a de-activation of individual nodes or even of portions of the network, in which the de-activated nodes can verify periodically possible reconfigurations of the control parameters and/or variations in the structure of the network itself, such as, for example, the addition or removal of nodes.

Of course, without prejudice to the principle of the invention, the details of construction and the embodiments may vary widely with respect to what is described and illustrated herein purely by way of example, without thereby departing from the scope of the present invention, as defined in the ensuing claims.

1. A method for managing a wireless sensor network comprising a plurality of sensor nodes, where said sensor nodes are configured for detecting physical quantities, wherein the method comprises the steps of:
setting at least one configuration parameter identifying a service density or monitoring resolution;
detecting for at least one sensor node of the plurality of sensor nodes which physical quantities are detected via respective surrounding sensor nodes of the plurality of sensor nodes of said sensor network;
verifying for said at least one sensor node whether said at least one sensor node is configured for detecting a physical quantity that is also detected via one of said respective surrounding sensor nodes; and
determining, according to said configuration parameter identifying a service density or monitoring resolution, whether said at least one sensor node must activate or de-activate detection of said physical quantity that is also detected via said respective surrounding sensor nodes.

2. The method according to claim 1, wherein said detection for at least one sensor node of which physical quantities are detected via said respective surrounding sensor nodes of said sensor network comprises the steps of:
sending to said surrounding sensor nodes a request; and
receiving from said surrounding sensor nodes information that enables identification of which physical quantities are detected via said respective surrounding sensor nodes.

3. The method according to claim 2, comprising the steps of:
determining for said at least one sensor node the identifications of the respective surrounding sensor nodes; and
sending to each surrounding sensor node of said surrounding sensor nodes a respective request.

4. The method according to claim 1, wherein each sensor node of the plurality of sensor nodes discloses at pre-set instants information that enables identification of which physical quantities are detected via the sensor node.

5. The method according to claim 1, comprising the step of:
setting for a plurality of physical quantities that can be detected via said sensor network respective configuration parameters identifying respective service densities or respective monitoring resolutions.

6. A sensor node for a sensor network comprising a transceiver for a wireless communication, at least one sensor configured for detecting physical quantities, and a control unit configured for:
detecting which physical quantities are detected via respective surrounding sensor nodes of said sensor network;
verifying whether said sensor node comprises a sensor configured for detecting a physical quantity that is also detected via one of said respective surrounding sensor nodes; and
determining, according to a configuration parameter identifying a service density or monitoring resolution, whether said detection of said physical quantity that is also detected via said respective surrounding sensor nodes must be activated or de-activated.

7. The sensor node according to claim 6, wherein said control unit is configured for:
receiving via said transceiver said configuration parameter identifying a service density or monitoring resolution.

8. The sensor node according to claim 6, wherein said transceiver is a Wireless Fidelity transceiver.

9. A sensor network comprising a plurality of sensor nodes according to claim 6.

10. A computer program product that can be loaded into the memory of at least one computer and comprises portions of software code for implementing the method according to claim 1.

11. The sensor node according to claim 7, wherein said transceiver is a Wireless Fidelity transceiver.

12. A sensor network comprising a plurality of sensor nodes according to claim 7.

13. A sensor network comprising a plurality of sensor nodes according to claim 8.

14. A computer program product that can be loaded into the memory of at least one computer and comprises portions of software code for implementing the method according claim 2.

15. A computer program product that can be loaded into the memory of at least one computer and comprises portions of software code for implementing the method according claim 3.

16. A computer program product that can be loaded into the memory of at least one computer and comprises portions of software code for implementing the method according claim 4.

17. A computer program product that can be loaded into the memory of at least one computer and comprises portions of software code for implementing the method according claim 5.
